(19) United States
(12) Patent Application Publication
(10) Pub. No.: US 2014/0215085 A1
(43) Pub. Date: Jul. 31, 2014

(54) SYSTEM AND METHOD FOR ROBUST ADAPTATION IN ADAPTIVE STREAMING

(71) Applicants: Zhi Li, Mountain View, CA (US); Xiaoqing Zhu, Austin, TX (US); Rong Pan, Saratoga, CA (US); Joshua B. Gahm, Newtonville, MA (US); Ali C. Begen, London (CA); David R. Oran, Cambridge, MA (US)

(72) Inventors: Zhi Li, Mountain View, CA (US); Xiaoqing Zhu, Austin, TX (US); Rong Pan, Saratoga, CA (US); Joshua B. Gahm, Newtonville, MA (US); Ali C. Begen, London (CA); David R. Oran, Cambridge, MA (US)

(73) Assignee: CISCO TECHNOLOGY, INC., San Jose, CA (US)

(21) Appl. No.: 13/750,223

(22) Filed: Jan. 25, 2013

(51) Int. Cl. H04L 29/06

(52) U.S. Cl. CPC H04L 65/60
USPC 709/231

(57) ABSTRACT

A method is provided in one example embodiment and includes receiving media data at an adaptive streaming client; updating an estimated available bandwidth associated with a media stream associated with the media data; filtering the estimated available bandwidth; mapping the filtered estimated available bandwidth to a media bitrate for the media stream; and updating a target segment delay that is to control time intervals between consecutive segment downloads of the media stream.

### TECHNICAL FIELD

This disclosure relates in general to the field of communications and, more particularly, to a system and a method for robust rate adaptation in adaptive streaming environments.

### BACKGROUND

End users have more media and communications choices than ever before. A number of prominent technological trends are currently afoot (e.g., more computing devices, more online video services, more Internet video traffic), and these trends are changing the media delivery landscape. Separately, these trends are pushing the limits of capacity and, further, degrading the performance of video, where such degradation creates frustration amongst end users, content providers, and service providers. In many instances, the video data sought for delivery is dropped, fragmented, delayed, or simply unavailable to certain end users.

Adaptive Streaming is a technique used in streaming multimedia over computer networks. While in the past, most video streaming technologies used either file download, progressive download, or custom streaming protocols, most of today's adaptive streaming technologies are based on hypertext transfer protocol (HTTP). These technologies are designed to work efficiently over large distributed HTTP networks such as the Internet.

HTTP-based Adaptive Streaming (HAS) operates by tracking a user's bandwidth and CPU capacity, and then selecting an appropriate representation (e.g., bandwidth and resolution) among the available options to stream. Typically, HAS leverages the use of an encoder that can encode a single source video at multiple bitrates and resolutions (e.g., representations), which can be representative of either constant bitrate encoding (CBR) or variable bitrate encoding (VBR). The player client can switch among the different encodings depending on available resources. Ideally, the result of these activities is little buffering, fast start times, and good video quality experiences for both high-bandwidth and low-bandwidth connections.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for providing rate adaptation in adaptive streaming environments in accordance with one embodiment of the present disclosure;

FIG. 1B is a simplified block diagram illustrating a possible adaptive streaming scenario;

FIG. 1C is a simplified block diagram illustrating possible example details associated with one embodiment of the present disclosure;

FIG. 2 is a simplified graphical illustration associated with scheduling segment downloading in accordance with one embodiment of the present disclosure;

FIG. 3 is a simplified graphical illustration associated with weighted bandwidth sharing in accordance with one embodiment of the present disclosure;

FIG. 4 is a simplified flowchart illustrating potential operations associated with the communication system in accordance with one embodiment of the present disclosure; and

FIG. 5 is a simplified graphical illustration depicting results of a number of streams sharing a particular link associated with the communication system.

### DETAILED DESCRIPTION OF EXAMPLE EMBODIMENTS

### Overview

A method is provided in one example embodiment and includes receiving media data at an adaptive streaming client (e.g., a hypertext transfer protocol (HTTP)-based Adaptive Streaming (HAS) client), and while also measuring and updating an estimate of the available bandwidth for carrying the media stream containing the media data. The ‘estimated available bandwidth’ is reflective of any bandwidth associated with any path (wired, wireless, satellite, etc.) to which the HAS client can utilize for receiving the video data. The method also includes filtering the available bandwidth estimates; mapping the filtered available bandwidth estimate to a desired media bitrate for the media stream; and updating a target segment delay. The ‘target segment delay’ is associated with any suitable timing characteristic, time interval, time period, pause, rest, waiting period, intermission, etc. that can be used in such a scenario. For example, the target segment delay can be used to control time intervals between consecutive segment downloads of the media stream.

In more particular embodiments, the filtering includes applying a low-pass filter to produce a noise-filtered version of the estimated available bandwidth. In other embodiments, the mapping includes converting a continuous value (for the bandwidth estimate) to a discrete media bitrate using a quantization function (e.g., which can include any activity associated with constraining something from a relatively large or continuous set of values (such as the real numbers) to a relatively small discrete set (such as the integers)). Other example implementations may include using historical data to initially set a media bitrate for retrieving particular media data. In yet other embodiments, the method may include inferring congestion on a path, which is shared by a plurality of HAS clients, where the congestion can be inferred by a reduction of segment downloading throughput, or an explicit notification of congestion via a control signal such as Explicit Congestion Notification (ECN).

In certain cases, a particular inter-download time of a cycle ‘n’ for the media stream is reflective of an interval between a beginning of downloading segment ‘n’ and a beginning of downloading segment ‘n+1’. A measured downloading throughput of a particular segment ‘n’ can be defined as a particular segment's data size divided by that segment's downloading duration. The updating of the target segment delay includes scheduling subsequent segment downloading. The scheduling can include setting a time to make download requests from the HAS client to a server for particular media data. As one possible alternative, a controller is used to evaluate a buffer size associated with particular media data and to adjust a corresponding target inter-segment delay. Note that the terms ‘adjust’ and ‘tune’ can include any activity associated with modifying, altering, moving, shifting, varying, or otherwise changing a particular rate, throughput, bandwidth allocation, media characteristic, etc.

### Example Embodiments

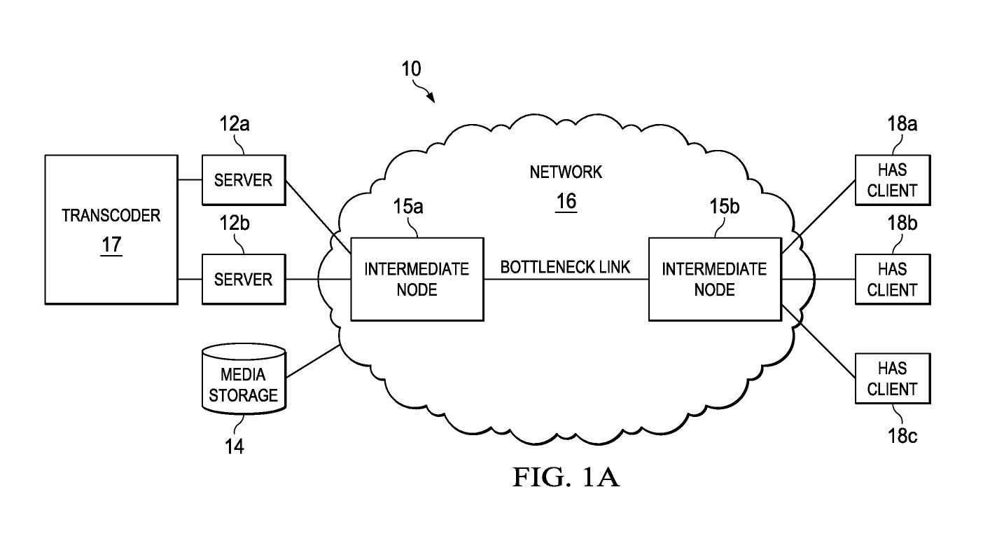

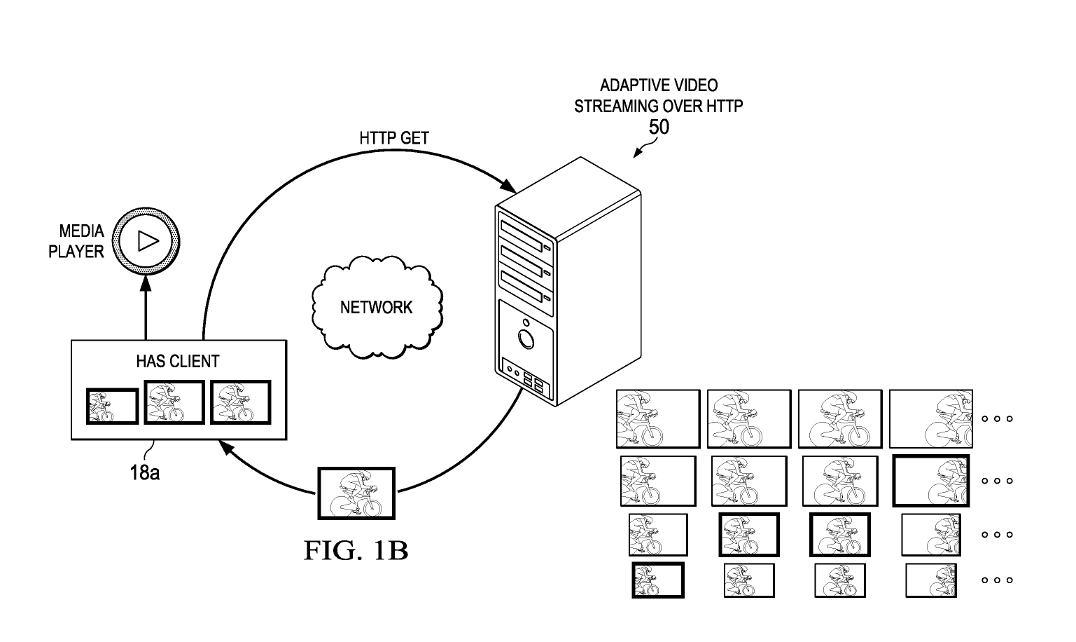

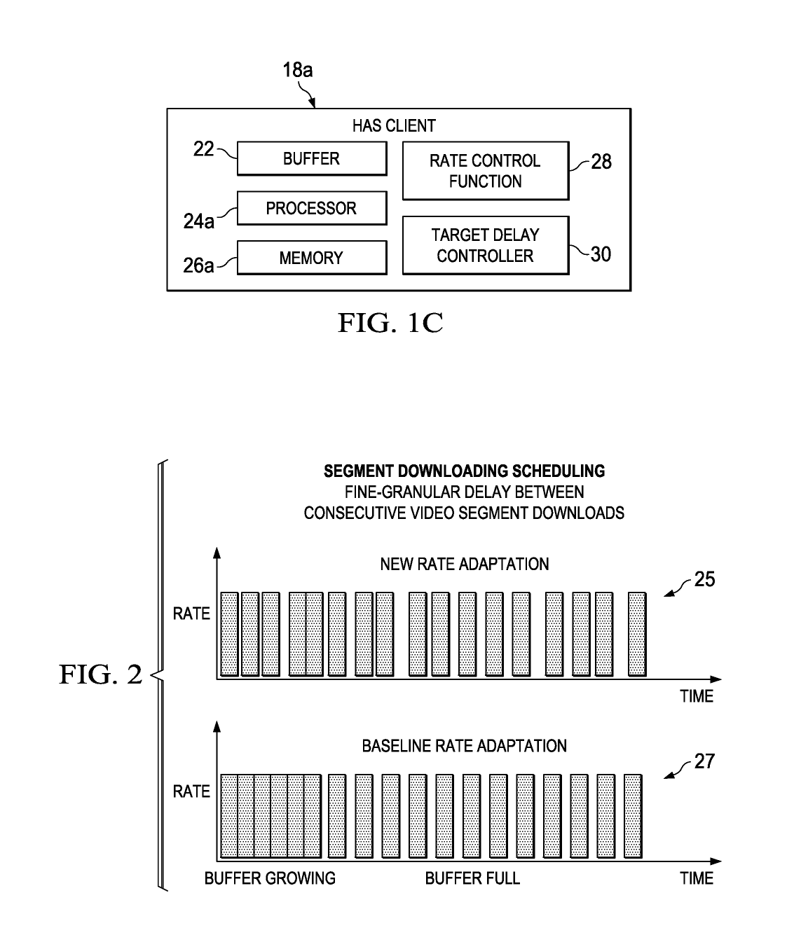

Turning to FIG. 1A, FIG. 1A is a simplified block diagram of a communication system 10 configured for providing rate adaptation for a plurality of HAS clients in accordance with one embodiment of the present disclosure. Communication system 10 may include a plurality of servers 12a-b, a media storage 14, a network 16, a transcoder 17, a plurality of HAS clients 18a-c, and a plurality of intermediate nodes 15a-b. Note that the originating video source may be a transcoder that takes a single encoded source and “transcodes” it into multiple rates, or it could be a “Primary” encoder that takes an original non-encoded video source and directly produces the multiple rates. Therefore, it should be understood that transcoder 17 is representative of any type of multi-rate encoder, transcoder, etc.

Servers 12a-b are configured to deliver requested content to HAS clients 18a-c. The content may include any suitable information and/or data that can propagate in the network (e.g., video, audio, media, any type of streaming information, etc.). Certain content may be stored in media storage 14, which can be located anywhere in the network. Media storage 14 may be a part of any Web server, logically connected to one of servers 12a-b, suitably accessed using network 16, etc. In general, communication system 10 can be configured to provide downloading and streaming capabilities associated with various data services. Communication system 10 can also offer the ability to manage content for mixed-media offerings, which may combine video, audio, games, applications, channels, and programs into digital media bundles.

In accordance with the techniques of the present disclosure, the architecture of FIG. 1A can provide a new rate adaptation framework that includes several significant mechanisms. First, the architecture can use an algorithm to adjust a flow's average throughput to match the available bandwidth. Second, the architecture can fine-tune the intervals between consecutive segment downloads. Additionally, the framework can offer an enhancement (via a new time discount addition) to an additive-increase/multiplicative-decrease (AIMD) equation, as detailed below. It can also make use of the fine-tuned interval between consecutive segment downloads, where the rate adaptation achieves weighted bandwidth sharing regardless of the underlying transport protocol's (e.g., TCP, SCTP, MP-TCP, etc.) behavior.

In certain example embodiments, the proposed rate adaptation algorithm can effectively mitigate the frequent rate shifts (e.g., rate oscillation) problems commonly experienced by typical HAS clients, especially when multiple HAS clients compete for bandwidth at one or more network bottleneck links. Typical HAS clients simply rely on the underlying TCP's bandwidth sharing behavior to choose a bitrate. By contrast, the framework discussed herein is able to decouple the bitrate selection from its underlying TCP's bandwidth sharing behavior. Many existing HAS clients implement a symmetric rate upshift/downshift. Embodiments of the present disclosure are able to achieve downshifts more responsively than the upshifts.

One significant aspect of example embodiments of the present disclosure includes an algorithm for proactively probing for available network bandwidth by requesting higher-bitrate video segments. In addition, certain embodiments of the present disclosure can apply to both the streaming of stored and live contents. Additionally, in implementing the probe-adapt principle and the fine-tuning of inter-request intervals, certain embodiments of the present disclosure can achieve both high video rates and excellent video rate stability.

Before detailing these activities in more explicit terms, it is important to understand some of the bandwidth challenges encountered in a network that includes HAS clients. The following foundational information may be viewed as a basis from which the present disclosure may be properly explained. Adaptive streaming video systems make use of multi-rate video encoding and an elastic IP transport protocol suite (typically hypertext transfer protocol/transmission control protocol/Internet protocol (HTTP/TCP/IP), but could include other transports such as HTTP/SPDY/IP, etc.) to deliver high-quality streaming video to a multitude of simultaneous users under widely varying network conditions. These systems are typically employed for “over-the-top” video services, which accommodate varying quality of service over network paths.

In adaptive streaming, the source video is encoded such that the same content is available for streaming at a number of different rates (this can be via either multi-rate coding, such as H.264 AVC, or layered coding, such as H.264 SVC). The video can be divided into “chunks” of one or more group-of-pictures (GOP) (e.g., typically two (2) to ten (10) seconds of length). HAS clients can access chunks stored on servers (or produced in near real-time for live streaming) using a Web paradigm (e.g., HTTP GET operations over a TCP/IP transport), and they depend on the reliability, congestion control, and flow control features of TCP/IP for data delivery. HAS clients can indirectly observe the performance of the fetch operations by monitoring the delivery rate and/or the fill level of their buffers and, further, either upshift to a higher encoding rate to obtain better quality when bandwidth is available, or downshift in order to avoid buffer underruns and the consequent video stalls when available bandwidth decreases, or stay at the same rate if available bandwidth does not change. Compared to inelastic systems such as classic cable TV or broadcast services, adaptive streaming systems use significantly larger amounts of buffering to absorb the effects of varying bandwidth from the network.

In a typical scenario, HAS clients would fetch content from a network server in segments. Each segment can contain a portion of a program, typically comprising a few seconds of program content. [Note that the term ‘segment’ and ‘chunk’ are used interchangeably in this disclosure.] For each portion of the program, there are different segments available with higher and with lower encoding bitrates: segments at the higher encoding rates require more storage and more transmission bandwidth than the segments at the lower encoding rates. HAS clients adapt to changing network conditions by selecting higher or lower encoding rates for each segment requested, requesting segments from the higher encoding rates when more network bandwidth is available (and/or the client buffer is close to full), and requesting segments from the lower encoding rates when less network bandwidth is available (and/or the client buffer is close to empty).

With most adaptive streaming technologies, it is common practice to have every segment represent the same, or very nearly the same, interval of program time. For example, in the case of one streaming protocol, it is common practice to have every segment (referred to as a ‘fragment’) of a program represent almost exactly 2 seconds worth of content for the program. With HTTP Live Streaming (HLS), it is quite common practice to have every segment of a program represent almost exactly 10 seconds worth of content. Although it is also possible to encode segments with different durations (e.g., using 6-second segments for HLS instead of 10-second segments), even when this is done, it is nevertheless common practice to keep all segments within a program at the same duration.

Turning to FIG. 1B, FIG. 1B is a simplified block diagram illustrating an environment 50 for providing adaptive video streaming over HTTP. This particular system can include a media player, a client buffer, multiple service providers, multiple content providers, and a network over which content can be exchanged. A client can download the segments in any order using plain HTTP GETs, measure the available bandwidth based on the download history, and select the video bitrate of the next segment on-the-fly. Typically, tens of seconds of downloaded video segments are buffered at the client to absorb unexpected bandwidth fluctuation. A viable rate adaptation algorithm should generally yield a high average video quality, a low variation of video quality, and offer a low chance of video playout stall caused by buffer underruns.

Certain embodiments of the present disclosure can provide a new rate adaptation algorithm for adaptive streaming that achieves several potential benefits. First, typical HAS clients estimate the available bandwidth by equating it to the measured throughput of downloading the previous several segments (i.e., historical data, which is inclusive of any information associated with previous media activity). When two or more HAS clients compete for bandwidth at some network bottleneck link, this turns out to be an inappropriate way of estimating bandwidth and, further, doing so results in frequent shifts and oscillations of the video bitrate requested. Example embodiments of the present disclosure can offer a new rate adaptation algorithm to solve these (and potentially other) problems. The HAS clients implementing such an approach would not suffer from the rate shifts/oscillation when they compete for bandwidth at network bottleneck links.

Second, when competing for bandwidth at a network bottleneck link, typical HAS clients rely on their underlying TCPs' bandwidth sharing behavior. This may sometimes be undesirable. For example, the resulting bitrate may be unfairly biased against clients with long Round-Trip Times (RTTs). As another example, when a High-Definition (HD) video stream shares bandwidth with a Standard Definition (SD) stream, the HD stream should purposely have access to more bitrate. Certain embodiments of the present disclosure are able to decouple the stream bitrate selection behavior from the underlying TCP's. This can enable any number of application scenarios including, but are not limited to, the examples described herein.

Third, in adaptive streaming scenarios, the objective of avoiding video playout stall is generally associated with the responsiveness of downshifting, but not upshifting. Stated in different terms, there is an asymmetry between the two. Therefore, it is desirable to have an asymmetric rate shift behavior, where the downshift ought to be more responsive (or more aggressive in reducing its bandwidth use than upshift is in increasing it) than the upshift. Certain embodiments of the present disclosure are able to achieve this property. It should also be noted that in certain example implementations, the activities outlined herein can be accommodated entirely by a client-side modification to current HAS solutions, and it would not require changes to the network, to the server, etc.

Turning to FIG. 1C, FIG. 1C is a simplified block diagram illustrating one possible set of details associated with communication system 10. This particular configuration includes HAS client 18a being provisioned with a buffer 22, a processor 24a, a memory 26a, a rate control function 28, and a target delay controller 30. Buffer 22 can be configured to buffer content received at a receiver (e.g., HAS client 18a). Rate control function 28 can be configured to monitor buffer 22 and determine a status of buffer 22. Target delay controller 30 can be configured to monitor the state of the content stream that the receiver (e.g., HAS client 18a) is receiving.

In operation, the elements of HAS client 18a can provide a rate adaptation algorithm that incorporates an Additive-Increase/Multiplicative-Decrease (AIMD) mechanism to gradually adjust the average throughput to match the available bandwidth. It should be noted that the AIMD algorithm does not directly adjust the (discrete) video bitrate; instead, it adjusts the average throughput used, which is equal to the segment size divided by the time interval between the beginning of downloading the current segment and the next segment. In addition, it should be noted that, in using such a framework, congestion would be inferred by the reduction of segment downloading throughput (or equivalently, the increase in segment downloading duration). By contrast, in comparable systems, congestion is generally inferred by packet losses. Additionally, the mechanisms of HAS client 18a can fine-tune the interval between consecutive video segment downloads (e.g., using a proportional-integral (PI) controller, which is being represented by target delay controller 30 in FIG. 1C).

In at least one example, a controller is used for determining the interval between consecutive segment downloads. For example, a proportional-integral controller (PI controller) (associated with control theory) is a special case of a PID controller in which the derivative (D) of the error is not used. Hence, a PI controller would be an optional module for scheduling the segment downloading. Other controllers could also be used without departing from the scope of the present disclosure. Note that any such controller is entirely optional and, accordingly, certain embodiments do not make use of this controller in order to achieve the operations discussed herein. The following equation can be part of such an implementation:

$$T [ \hat{n} ] = \frac{r [ n ] \cdot τ}{\hat{y} [ n ]} + β \cdot ( B [ n - 1 ] - {B}_{0} )$$

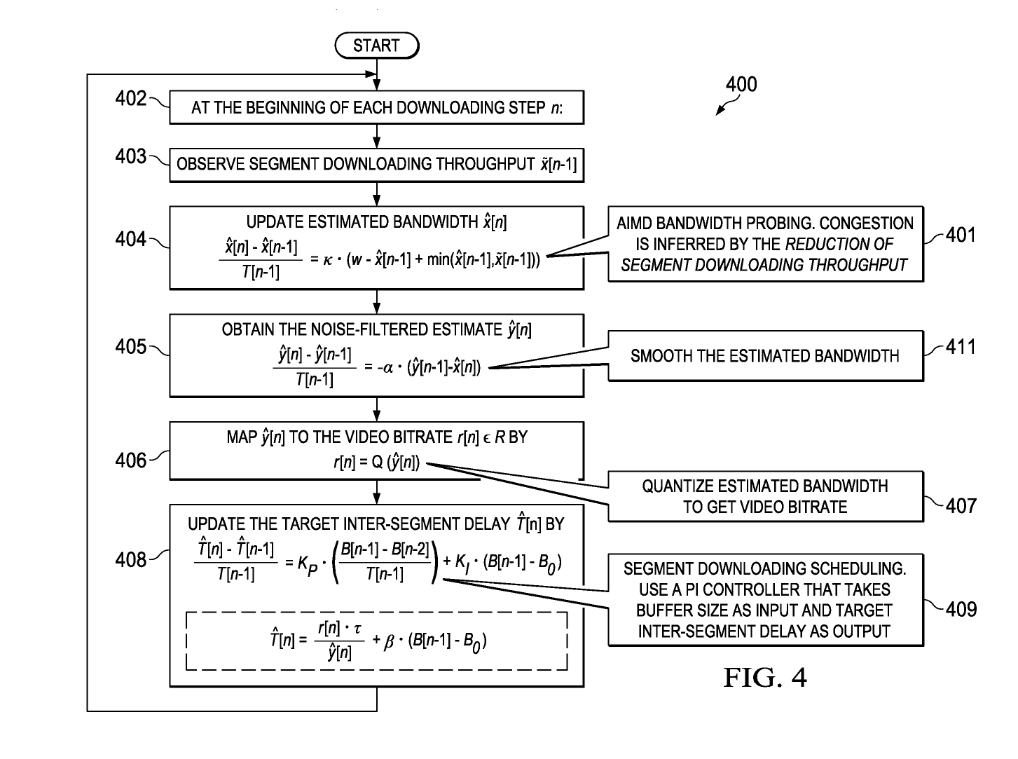

This equation is reflected in 408 of FIG. 4. In this instance, beta is positive real number that can control the convergence rate of buffer B[n−1] towards the reference buffer B₀. Additionally, the notations of the equations discussed herein are defined as follows:
x_hat[n]: The target average throughput at downloading cycle n.
x_tilde[n]: The measured downloading throughput of segment n, defined as the segment's data size divided by the segment downloading duration (excluding the *off* interval between downloads).
T[n]—The actual inter-download time of cycle n (i.e., the interval between the beginning of downloading segment n and the beginning of downloading segment n+1)
k—The convergence rate in AIMD algorithm.
τ (Greek letter tau)—the nominal duration of each segment.
w—The AI weight in AIMD.
T_hat[n]—The target inter-download time of cycle n, which may be less or equal to T[n].
B[n]—The duration of video buffered at the client (in video seconds).
K_{P}—The proportional gain in PI controller.
K_{I}—The integral gain in PI controller.
B₀—The reference buffer duration that the client tries to maintain.

Separately, the framework of HAS client 18a makes use of the additional degree of freedom introduced by the fine-tuning of the download interval to achieve a weighted bandwidth sharing among HAS clients that are competing for bandwidth at some bottleneck link (regardless of the fair or unfair sharing of the clients' underlying TCP behaviors). Intuitively, an HAS client with less bandwidth (for the same video bitrate) would have a longer download interval and vice versa. Additional details associated with these activities are discussed below with reference to several equations, scenarios, and activities that are illustrative of at least some of the embodiments of the present disclosure.

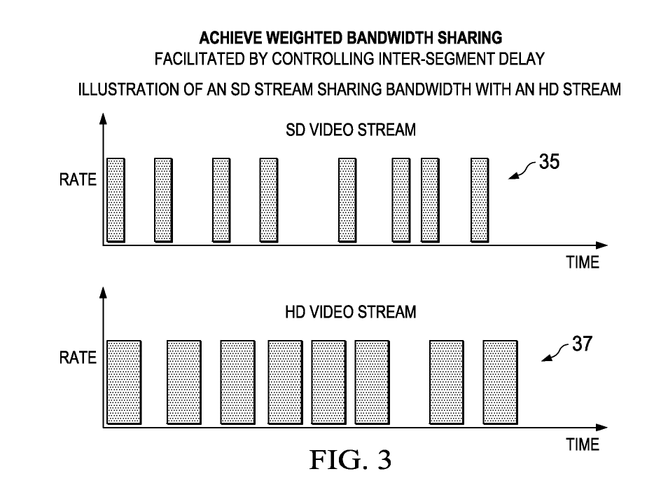

Turning to FIG. 2, FIG. 2 illustrates a set of graphical illustrations 25 and 27 reflective of scheduling segment downloading. The new rate adaptation model discussed herein is reflected first, where a comparison is being made with the baseline rate adaptation. In this particular set of illustrations, the rate is being depicted on one axis, while time (as the buffer grows more full) is being reflected on the other. In operation, the algorithm of the present disclosure can continuously adjust system variables towards a steady state. By contrast, a baseline algorithm would attempt to directly choose the video bitrate based on the measured segment downloading throughput. Additionally, the algorithm of the present disclosure can implement an asymmetric rate-shifting model, where a conservative upshift allows breathing room, buffer growth, and system stability, while a more responsive downshift would avoid catastrophic playout stalls when the bandwidth drops. Hence, in one sense, embodiments of the present disclosure do not necessarily offer asymmetry itself, but offer the non-linear behavior for downshift for the same relative change in bandwidth, of which AIMD is one possible variant.

FIG. 3 illustrates a set of graphical illustrations 35 and 37 that are reflective of weighted bandwidth sharing that may be facilitated by controlling inter-segment delay. More specifically, a standard-definition (SD) video stream is being compared to a high-definition (HD) video stream. In a baseline rate adaptation algorithm (typically employed by a conventional HAS client), a number of potential steps are performed. For example, in the baseline case, in a first step, a system would equate an estimated bandwidth to the segmented downloading throughput. In a second step, the estimated bandwidth would be smoothed out. In a third step, the estimated bandwidth would be quantized to identify the corresponding video bitrate. Finally, the segment downloading would be scheduled depending on the buffer fullness. One salient issue associated with these computations (using the above-described methods) is that the HAS client cannot both achieve a good throughput and reach steady state. One fundamental problem is that the bandwidth estimation takes in no information about the ‘off’ period. It becomes impossible for the client to distinguish certain scenarios and, further, to make a sound decision regarding upshifting activities.

By contrast, the framework of the present disclosure can probe the bandwidth by increasing the requested the data rate and monitoring the resulting downloading throughput. If the throughput indicates that congestion is induced, then the system can quickly back off by dropping the requested data rate. Otherwise, the system would continue to probe the bandwidth by further increasing the rate. Additionally, the framework can fine-tune the inter-segment delay and treat the average throughput as a continuous variable. Then, the AIMD can be applied to the average throughput, instead of the discrete video bitrates. Further, the framework can adjust the inter-segment delay based on a buffer size. Note that certain embodiments of the present disclosure allows an SD video stream to share a smaller portion of network bandwidth than a concurrent HD stream, whereas baseline algorithms will inevitably lead to equal bandwidth sharing via TCP.

Turning to FIG. 4, FIG. 4 is a simplified flowchart illustrating one set of possible activities 400 associated with the present disclosure. This particular flow may begin at 402, where at the beginning of each downloading step n (n=1, 2, 3, . . . ), the following occurs (at indicated generally at 404):

Update the estimated available bandwidth \hat{x}[n] by

$$\frac{\hat{x} [ n ] - \hat{x} [ n - 1 ]}{T [ n - 1 ]} = κ \cdot ( w - \hat{x} [ n - 1 ] + min ( \hat{x} [ n - 1 ] , \tilde{x} [ n - 1 ] ) )$$

and its noise-filtered version ŷ[n] by

$$\frac{\hat{y} [ n ] - \hat{y} [ n - 1 ]}{T [ n - 1 ]} = α \cdot ( \hat{y} ( n - 1 ] - \hat{x} [ n ] )$$

Additionally, the AIMD bandwidth probing is executed (shown by a comment 401). Congestion can be inferred by the reduction of segment downloading throughput (as indicated by a comment 403). In addition, the noise-filtered estimate is obtained (405), where the estimated bandwidth is smoothed (shown generally at 411). At 406, the estimated bandwidth is quantized to identify the appropriate video bitrate (shown generally at 406 and identified by a comment 407). Additionally, the target inter-segment delay is updated at 408 (both of these computations being shown below).

Map ŷ[n] the video bitrate r[n]ε [symbol] by

r[n]=Q(ŷ[n])

Update the target r-segment delay \hat{T}[n] by

$$\frac{\hat{T} [ n ] - \hat{T} [ n - 1 ]}{T [ n - 1 ]} = {K}_{P} \cdot ( \frac{B [ n - 1 ] - B [ n - 2 ]}{T [ n - 1 ]} ) + {K}_{I} \cdot ( B [ n - 1 ] - {B}_{0} )$$

More specifically, the segment downloading is scheduled (shown generally by a comment 409). In at least one example, the controller is used to take the current buffer size as input, and the target inter-segment delay as the output.

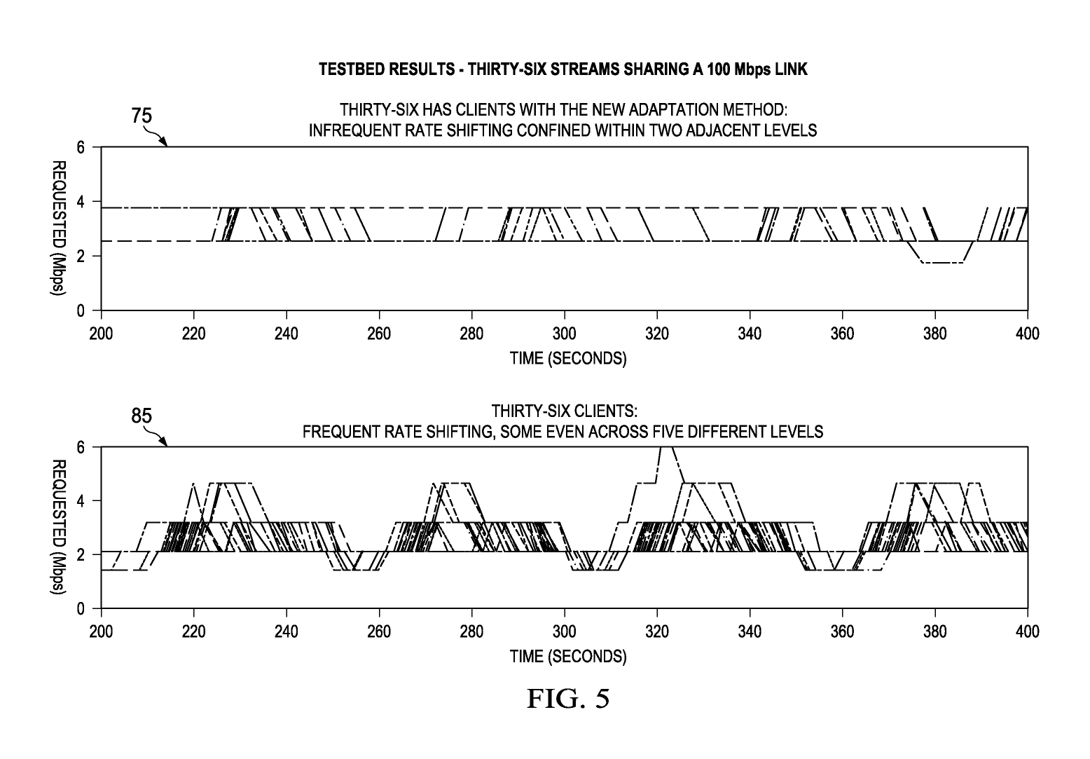

Turning to FIG. 5, FIG. 5 depicts a set of graphical illustrations 75 and 85 associated with streams sharing a particular link. In one specific example, graphical illustrations 75 and 85 are associated with 36 HAS clients sharing a 100 Mbps link. In these particular illustrations, time is provided on one axis, while the requested bitrate (in Mbps) is provided on the other axis. The new rate adaptation is reflected on the top graphical illustration in which infrequent rate shifting confined within two adjacent levels is achieved. By contrast, the bottom graphical illustration is associated with clients in which there is frequent rate shifting (in egregious cases, across five different levels, as shown).

Turning to the example infrastructure associated with the present disclosure, HAS clients 18a-c can be associated with devices, customers, or end users wishing to receive data or content in communication system 10 via some network. The term ‘HAS client’ is inclusive of devices used to initiate a communication, such as any type of receiver, a computer, a set-top box, an Internet radio device (IRD), a cell phone, a smart phone, a tablet, a personal digital assistant (PDA), a Google Android™, an iPhone™, an iPad™, or any other device, component, element, endpoint, or object capable of initiating voice, audio, video, media, or data exchanges within communication system 10. HAS clients 18a-c may also be inclusive of a suitable interface to the human user, such as a display, a keyboard, a touchpad, a remote control, or any other terminal equipment. HAS clients 18a-c may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

Transcoder 17 (or a multi-bitrate encoder) is a network element configured for performing one or more encoding operations. For example, transcoder 17 can be configured to perform direct digital-to-digital data conversion of one encoding to another (e.g., such as for movie data files or audio files). This is typically done in cases where a target device (or workflow) does not support the format, or has a limited storage capacity that requires a reduced file size. In other cases, transcoder 17 is configured to convert incompatible or obsolete data to a better-supported or more modern format.

Network 16 represents a series of points or nodes of interconnected communication paths for receiving and transmitting packets of information that propagate through communication system 10. Network 16 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber-to-the-x (FTTx), which is a generic term for any broadband network architecture that uses optical fiber in last-mile architectures, and data over cable service interface specification (DOCSIS) cable television (CATV). The architecture can also operate in junction with any 3G/4G/LTE cellular wireless and WiFi/WiMAX environments. The architecture of the present disclosure may include a configuration capable of transmission control protocol/internet protocol (TCP/IP) communications for the transmission and/or reception of packets in a network.

In more general terms, HAS clients 18a-c, transcoder 17, and servers 12a-b are network elements that can facilitate the rate adaptation activities discussed herein. As used herein in this Specification, the term ‘network element’ is meant to encompass any of the aforementioned elements, as well as routers, switches, cable boxes, gateways, bridges, load balancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, HAS clients 18a-c, transcoder 17 and/or servers 12a-b include software to achieve (or to foster) the rate adaptation activities discussed herein. This could include the implementation of instances of rate control function 28, target delay controller 30, and/or segmenting boundary control function 32. Additionally, each of these elements can have an internal structure (e.g., a processor, a memory element, etc.) to facilitate some of the operations described herein. In other embodiments, these rate adaptation activities may be executed externally to these elements, or included in some other network element to achieve the intended functionality. Alternatively, HAS clients 18a-c, transcoder 17, and servers 12a-b may include software (or reciprocating software) that can coordinate with other network elements in order to achieve the rate adaptation activities described herein. In still other embodiments, one or several devices may include any suitable algorithms, hardware, software, components, modules, interfaces, or objects that facilitate the operations thereof.

As used herein, the ‘time interval’ can include any suitable timing parameter associated with retrieving content (or, at least portions thereof). In one example, the time interval is being generated based on an algorithm. In certain scenarios, the time interval can be identified dynamically (e.g., in real time) and, further, such scenarios may or may not involve feedback associated with a particular time interval.

In certain alternative embodiments, the rate adaptation techniques of the present disclosure can be incorporated into a proxy server, web proxy, cache, content delivery network (CDN), etc. This could involve, for example, instances of segmenting boundary control function 32 and/or rate control function 28 being provisioned in these elements. Alternatively, simple messaging or signaling can be exchanged between an HAS client and these elements in order to carry out the activities discussed herein. In this sense, some of the rate adaptation operations can be shared amongst these devices.

In operation, such a CDN can provide bandwidth-efficient delivery of content to HAS clients 18a-c or other endpoints, including set-top boxes, personal computers, game consoles, smartphones, tablet devices, iPads, iPhones, Google Droids, customer premises equipment, or any other suitable endpoint. Note that servers 12a-b (previously identified in FIG. 1A) may also be integrated with or coupled to an edge cache, gateway, CDN, or any other network element. In certain embodiments, servers 12a-b may be integrated with customer premises equipment (CPE), such as a residential gateway (RG). Content chunks may also be cached on an upstream server or cached closer to the edge of the CDN. For example, an origin server may be primed with content chunks, and a residential gateway may also fetch and cache the content chunks.

As identified previously, a network element can include software (e.g., rate control function 28, target delay controller 30, and/or segmenting boundary control function 32, etc.) to achieve the rate adaptation operations, as outlined herein in this document. In certain example implementations, the rate adaptation functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor [processors 24a shown in FIG. 1C], or other similar machine, etc.). In some of these instances, a memory element [memory 26a shown in FIG. 1C] can store data used for the operations described herein. This includes the memory element being able to store instructions (e.g., software, code, etc.) that are executed to carry out the activities described in this Specification. The processor (e.g., processors 24a) can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the rate adaptation activities, as outlined herein. Additionally, each of these devices may include a processor that can execute software or an algorithm to perform the rate adaptation activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that while the preceding descriptions have addressed segment sizes employed in systems like Microsoft Smooth Streaming, the present disclosure could equally be applicable to other technologies. For example, Dynamic Adaptive Streaming over HTTP (DASH) is a multimedia streaming technology that could benefit from the techniques of the present disclosure. DASH is an adaptive streaming technology, where a multimedia file is partitioned into one or more segments and delivered to a client using HTTP. A media presentation description (MPD) can be used to describe segment information (e.g., timing, URL, media characteristics such as video resolution and bitrates). Segments can contain any media data and could be rather large. DASH is codec agnostic. One or more representations (i.e., versions at different resolutions or bitrates) of multimedia files are typically available, and selection can be made based on network conditions, device capabilities, and user preferences to effectively enable adaptive streaming. In these cases, communication system 10 could perform rate adaptation based on the individual client needs.

On another note, in DASH, an HAS client can ask for a byte range (i.e., rather than the whole segment, it can ask for a subsegment (e.g., the first two group of pictures (GOPs) inside that segment)). Stated in different terminology, clients have flexibility in terms of what they ask for (i.e., how much data). If the size of each (byte-range) request is varied on the client side by modifying the client behavior, the same rate adaptation effect can be achieved. In such an instance, what is not being changed is when the clients ask for a byte range. Instead, the architecture can change the size of the byte range (i.e., changing the size of the range). Consequently, the request times would vary as well since fetches will take a variable delay.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving media data at an adaptive streaming client;
updating an estimated available bandwidth associated with a media stream associated with the media data;
filtering the estimated available bandwidth;
mapping the filtered estimated available bandwidth to a media bitrate for the media stream; and
updating a target segment delay that is to control time intervals between consecutive segment downloads of the media stream.

2. The method of claim 1, wherein the filtering includes applying a low-pass filter to identify a noise-filtered version of the estimated available bandwidth.

3. The method of claim 1, wherein the mapping includes mapping a continuous value to a discrete media bitrate using a quantization function.

4. The method of claim 1, further comprising:
using historical data to initially select a particular media bitrate for retrieving particular media data.

5. The method of claim 1, further comprising:
inferring congestion on a path, which is shared by a plurality of adaptive streaming clients, wherein the congestion is inferred by a reduction of segment downloading throughput.

6. The method of claim 1, wherein a particular inter-download time of a cycle ‘n’ for the media stream is reflective of an interval between a beginning of downloading segment ‘n’ and a beginning of downloading segment ‘n+1’.

7. The method of claim 1, wherein a measured downloading throughput of a particular segment ‘n’ is defined as a particular segment's data size divided by a particular segment's downloading duration.

8. The method of claim 1, wherein the updating of the target segment delay includes scheduling segment downloading.

9. The method of claim 8, wherein the scheduling includes setting a time to send out downloading requests from the adaptive streaming client to a server for particular media data.

10. The method of claim 1, wherein a controller is used to evaluate a buffer size and to adjust a target inter-segment delay associated with particular media data.

11. The method of claim 1, further comprising:
incrementing a particular bitrate; and
monitoring a resulting downloading throughput based on the particular bitrate.

12. The method of claim 1, further comprising:
using an additive increase in estimated available bandwidth if a measured download rate exceeds a current estimate of available bandwidth; and
using a multiplicative decrease if the measured download rate is less than the current estimate of available bandwidth.

13. The method of claim 1, further comprising:
adjusting an average throughput to approximate a segment size divided by a time interval between a beginning of a downloading of a current segment and a next segment.

14. The method of claim 1, further comprising:
gradually adjusting an average throughput to match an available bandwidth.

15. The method of claim 1, further comprising:
tuning an inter-segment delay associated with consecutive video segments; and
utilizing an average throughput as a continuous variable such that an adaptive streaming protocol is applied to the average throughput.

16. The method of claim 1, further comprising:
selecting a video encoding rate based on a quantization of a noise-filtered available bitrate to one of a plurality of available encoding rates.

17. The method of claim 1, further comprising:
adjusting an inter-segment download interval based on a noise-filtered version of the estimated available bandwidth.

18. The method of claim 1, further comprising:
using a measured download rate as an indicator of available bandwidth if a measured download rate is less than a current estimate of available bandwidth.

19. The method of claim 1, further comprising:
tuning a time interval between consecutive video segment downloads associated with the media data, wherein a rate adaptation activity achieves a weighted bandwidth result that is indifferent to an underlying transport protocol's behavior.

20. One or more non-transitory tangible media that includes code for execution and when executed by a processor operable to perform operations comprising:
receiving media data at an adaptive streaming client;
updating an estimated available bandwidth associated with a media stream associated with the media data;
filtering the estimated available bandwidth;
mapping the filtered estimated available bandwidth to a media bitrate for the media stream; and
updating a target segment delay that is to control time intervals between consecutive segment downloads of the media stream.

21. An adaptive streaming client, comprising:
a processor;
a memory; and
a rate control function, wherein the adaptive streaming client is configured to:
receive media data;
update an estimated available bandwidth associated with a media stream associated with the media data;
filter the estimated available bandwidth;
map the filtered estimated available bandwidth to a media bitrate for the media stream; and
update a target segment delay that is to control time intervals between consecutive segment downloads of the media stream.

22. The adaptive streaming client of claim 21, further comprising:
a proportional-integral (PI) controller configured for scheduling segment downloading associated with the media stream.
